(19) United States
(12) Patent Application Publication
(10) Pub. No.: US 2008/0025272 A1
(43) Pub. Date: Jan. 31, 2008

(54) Access port for a wireless network

(75) Inventor: Edward Geiger, San Martin, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/497,018

(22) Filed: Jul. 31, 2006

(51) Int. Cl. H04Q 7/24

(52) U.S. Cl. 370/338

(57) ABSTRACT

A wireless local area network (WLAN) includes an access port coupled to a network; and a plurality of mobile units configured to receive outgoing data packets from the access port and to provide incoming data packets to the access port. The access port includes a processor and a packet encapsulation component. The packet encapsulation component can be formed by at least one of an FPGA and an ASIC.

### TECHNICAL FIELD

The present invention relates generally to wireless networks and, more particularly, to wireless networks with an access port.

### BACKGROUND

In recent years, there has been a dramatic increase in the demand for mobile connectivity solutions utilizing various wireless components and wireless networks, for example, wireless local area networks (WLANs). WLANs generally include, among other things, access ports that communicate with mobile units using one or more RF channels.

The access ports receive data packets transmitted from the wireless components and data packets to be transmitted to the wireless components. The wireless components can be, for example, mobile units. The access ports must process a large number of data packets, which can cause a great strain on the processor of the access port and result in a slower network. Conventional access ports attempt to solve this problem by increasing the processing speed of the processor, which correspondingly increases the cost of the access port.

Accordingly, it is desirable to provide a wireless network having an access port that more efficiently processes packets of data on a wireless network.

### BRIEF SUMMARY

In accordance with an embodiment of the present invention, a wireless local area network (WLAN) includes an access port coupled to a network; and a plurality of mobile units configured to receive outgoing data packets from the access port and to provide incoming data packets to the access port. The access port comprises a processor and a packet encapsulation component. The packet encapsulation component can be formed by at least one of an FPGA and an ASIC.

In accordance with another embodiment of the present invention, an access port is provided. The access port is to be coupled to a network and configured to transmit outgoing data packets to a plurality of mobile units and to receive incoming data packets from the plurality of mobile units. The access port includes a radio to receive the incoming data packets from the mobile units and to transmit the outgoing data packets to the mobile units; a packet encapsulation component coupled to the radio; a processor coupled to the packet encapsulation component; and an Ethernet connection coupled the processor and the packet encapsulation component and configured to be coupled to the network. The packet encapsulation component can be formed by at least one of an FPGA and an ASIC.

In accordance with another embodiment of the present invention, a method of manufacturing an access port is provided. The access port is to be coupled to a network and configured to transmit outgoing data packets to a plurality of mobile units and to receive incoming data packets from the plurality of mobile units. The method includes providing a radio to receive incoming data packets from the mobile units and to transmit outgoing data packets to the mobile units; providing a packet encapsulation component coupled to the radio; providing a processor coupled to the packet encapsulation component; and providing an Ethernet connection coupled the processor and the packet encapsulation component and configured to be coupled to the network. The packet encapsulation component can be formed by at least one of an FPGA and an ASIC.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a wireless network in accordance with an exemplary embodiment of the present invention; and

FIG. 2 is a schematic representation of an access port of the wireless network of FIG. 1.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely exemplary applications for the invention.

For the sake of brevity, conventional techniques related to signal processing, data transmission, signaling, network control, the 802.3 and 802.11 families of specifications, and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

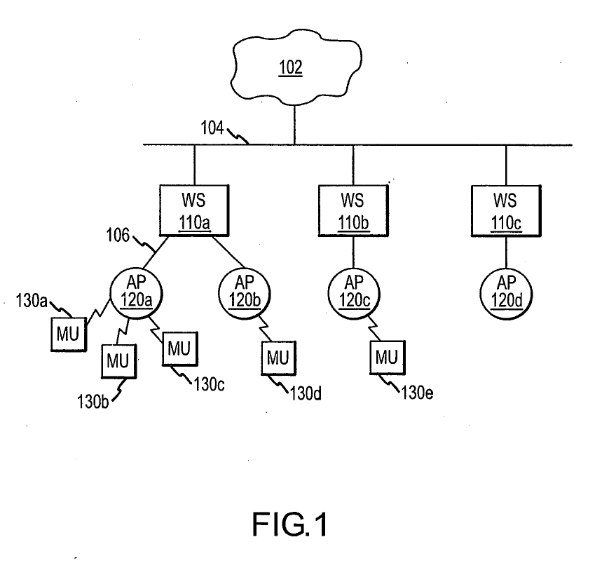

Referring to FIG. 1, one or more switching devices 110 (alternatively referred to as “wireless switches,” “WS,” or simply “switches”) are coupled to a network 104 (e.g., an Ethernet network coupled to one or more other networks or devices, indicated by network cloud 102). One or more access ports 120 (alternatively referred to as “access points” or “APs”) are configured to wirelessly connect to one or more mobile units 130 (alternatively referred to as “MUs”). The access ports 120 are suitably connected to corresponding wireless switches 110 via communication lines 106 (e.g., conventional Ethernet lines). Any number of additional and/or intervening switches, routers, servers and other network components may also be present in the system.

A particular access port 120 may have a number of associated mobile units 130. For example, in the illustrated topology, mobile units 130(a), 130(b), and 130(c) are associated with access point 120(a), while mobile unit 130(e) is associated with access point 120(c). Furthermore, one or more access ports 120 may be connected to a single wireless switch 110. Thus, as illustrated, access port 120(a) and access port 120(b) are connected to wireless switch 110(a), and access port 120(c) is connected to wireless switch 110(b).

Each wireless switch 110 determines the destination of data packets it receives over network 104 and routes that data packet to the appropriate access port 120 if the destination is a mobile unit 130 with which the access port 120 is associated. Each wireless switch 1 10 therefore maintains a routing list of mobile units 130 and their associated access points 130. These lists are generated using a suitable packet handling process known in the art. Thus, each access port 120 acts primarily as a conduit, sending/receiving data packets via RF transmissions with mobile units 130, and sending/receiving data packets via a network protocol with the wireless switch 110. In alternate embodiments, the wireless switches 110 are not utilized, and the access ports 120 are connected directly to the network.

The access ports 120 are typically capable of communicating with the mobile units 130 in accordance with the 802.11 standard and with the wireless switches in accordance with the 802.3 standard.

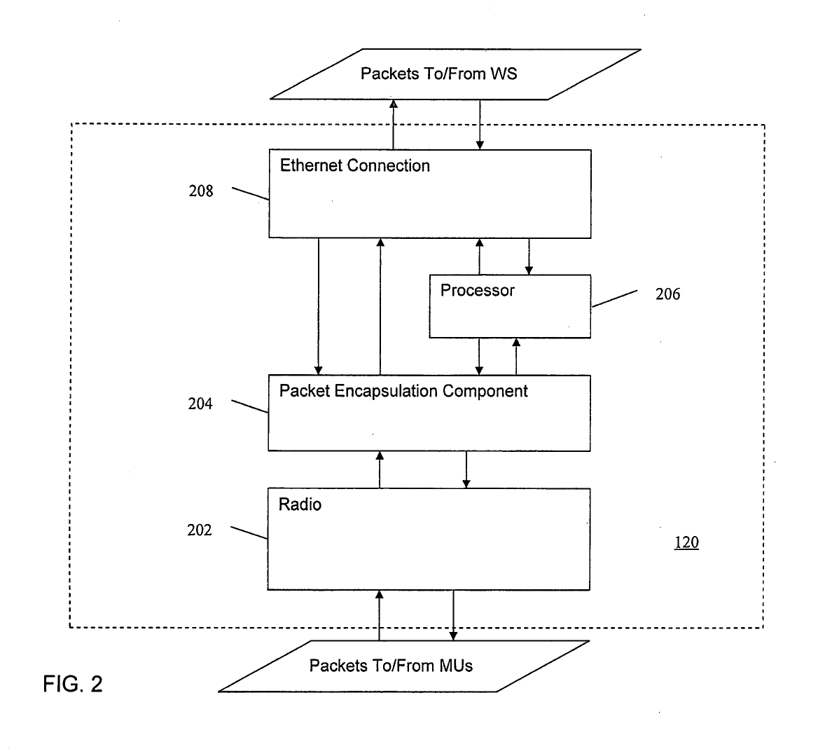

FIG. 2 illustrates an access port 120 in greater detail by describing some of the functional components of the access port 120 and data flow within the access port 120.

The access port 120 includes a radio 202 that transmits and receives packets to and from the mobile units 130. The radio 202 is coupled to a packet encapsulation component 204. The packet encapsulation component 204 is coupled to a processor 206 and an Ethernet connection 208. The processor 206 is also coupled to the Ethernet connection 208. The Ethernet connection 208 transmits and receives packets of data to and from the wireless switch 110.

Upon receiving a packet of data from the mobile unit 130, the radio 202 provides the packet to the packet encapsulation component 204. Generally, the access port 120 receives at least two types of data packets from the mobile unit 130. A control data packet is a data packet that must be processed by the processor 206 and typically includes data packets from a mobile unit 130 that is attempting to establish a connection with the access port 120 and its associated WLAN. A control data packet can also provide information necessary to maintain status and connections between the components of the network. A user data packet is a data packet sent to or from a mobile unit with an established connection. The packet encapsulation component 204 provides the control data packets to the processor 206, and the processor 206 may encapsulate and/or further process the control data packets. When the packet encapsulation component 204 receives a user data packet, the packet encapsulation component 204 encapsulates the user data packet. In the exemplary embodiment, the packet encapsulation component 204 encapsulates the user data packet in accordance with the 802.3 standard. The data encapsulation component 204 then provides the encapsulated user data packet to the Ethernet connection 208 for transmission to the wireless switch 110. Similarly, after the processor 206 provides the necessary processing to the control data packet, the processor 206 provides the control data packet to the Ethernet connection 208 for transmission to the wireless switch 110.

Upon receiving packets of data from the wireless switch 110 to be transmitted to the mobile unit 130, the Ethernet connection 208 provides the user data packets to the packet encapsulation component 204 and the control data packets to the processor 206. The packet encapsulation component 204 de-encapsulates the data packets in accordance with the 802.11 standard. The packet encapsulation component 204 will then provide the data packets to the radio 202 for transmission to the mobile unit 130. Alternately, the Ethernet connection 208 can provide control data packets to the packet encapsulation component 204, which then provides the control data packets to the processor 206.

In the exemplary embodiment, the packet encapsulation component 204 encapsulates and de-encapsulates the data packets with a wireless switch protocol (“WISP”). The WISP protocol is a messaging system used to exchange data between the switch 110 and the access ports 120. The WISP protocol can be used to send control and status information between the switch 110 and the access ports 120, and can also contain 802.3 packets received by the access ports 120 for the switch 110 or sent by the switch 110 to the access ports 120 for transmission to the mobile units 130.

The packet encapsulation component 204 can be formed by a Field-Programmable Gate Array (FPGA) or any type of semiconductor device containing programmable logic components and interconnects. Similarly, the packet encapsulation component 204 can be formed by an application-specific integrated circuit (ASIC). Particularly, the packet encapsulation component 204 is formed by an FPGA or ASIC instead of providing the packet encapsulation function in the processor 206. This reduces the processing cycles necessary to handle the data packets, and as a result, reduces the necessary speed and cost of the processor 204.

In addition to encapsulating and de-encapsulating the data packets, the packet encapsulation component 204 can also provide a queuing function for the radio 202 to schedule outgoing packets. Moreover, the packet encapsulation component 204 can provide a buffer management or data flow control function for the access port 120. As an example, the packet encapsulation component 204 can provide signals to the wireless switch 110 concerning the amount of data that the access port can transmit at a particular moment. In an exemplary embodiment, the radio 202 can include an encryption engine to decrypt encrypted data packets from the mobile units 130. The packet encapsulation component 204 can include the encryption keys necessary for the radio 202 to decrypt the encrypted data packets. Moreover, the packet encapsulation component 204 can provide the encryption keys with encrypted data packets transmitted from the switch 110.

The Ethernet connection 208 can be any component that provides a connection to the switch 110. For example, the Ethernet connection 208 can be a stand-alone MAC and PHY chip, or a MAC component can form part of the packet encapsulation component 204 and the PHY component can be a separate chip. The Ethernet connection 208 can be a 10/100/1000M bit copper or fiber component.

Unless otherwise noted, various tasks performed in connection with the processes and systems shown herein may be performed by software, hardware, firmware, or any combination thereof. Although FIG. 2 illustrates that the packet encapsulation component 204 formed by an FPGA or an ASIC may be located in the access port 120, the packet encapsulation component 204 alternately may be located in an access point, mobile units, wireless switches, or in any combination thereof. It should be appreciated that the processes and systems may include any number of additional or alternative tasks or components, that the tasks and components shown herein need not be performed or arranged in the illustrated order, and that the illustrated processes and systems may be incorporated into a more comprehensive system or process having additional functionality not described in detail herein.

It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A wireless local area network (WLAN) comprising:
an access port coupled to a network; and
a plurality of mobile units configured to receive outgoing data packets from the access port and to provide incoming data packets to the access port,
wherein the access port comprises a processor and a packet encapsulation component, and wherein the packet encapsulation component is formed by at least one of an FPGA and an ASIC.

2. The WLAN of claim 1, wherein the packet encapsulation component encapsulates at least some the incoming data packets in accordance with an 802.3 standard and de-encapsulates at least some the outgoing data packets in accordance with an 802.11 standard.

3. The WLAN of claim 2, wherein the incoming and outgoing data packets comprise user data packets and control data packets, and wherein the at least some incoming and outgoing data packets are user data packets.

4. The WLAN of claim 1, wherein the packet encapsulation component includes storage for encryption keys.

5. The WLAN of claim 1, wherein the packet encapsulation component queues the outgoing data packets for transmission to the mobile units.

6. The WLAN of claim 1, further comprising a switch to couple the access port to the network.

7. The WLAN of claim 6, wherein the packet encapsulation component provides signals to the switch related to flow control of the outgoing data packets.

8. The WLAN of claim 1, wherein the access port further comprises an Ethernet connection to couple the processor and the packet encapsulation component to the network, and a radio to receive incoming data packets from the mobile units and to transmit outgoing data packets to the mobile units.

9. An access port to be coupled to a network and configured to transmit outgoing data packets to a plurality of mobile units and to receive incoming data packets from the plurality of mobile units, the access port comprising:
a radio to receive the incoming data packets from the mobile units and to transmit the outgoing data packets to the mobile units;
a packet encapsulation component coupled to the radio;
a processor coupled to the packet encapsulation component; and
an Ethernet connection coupled the processor and the packet encapsulation component and configured to be coupled to the network,
wherein the packet encapsulation component is formed by at least one of an FPGA and an ASIC.

10. The access port of claim 9, wherein the packet encapsulation component encapsulates at least some the incoming data packets in accordance with an 802.3 standard and de-encapsulates at least some the outgoing data packets in accordance with an 802.11 standard.

11. The access port of claim 10, wherein the incoming and outgoing data packets comprise user data packets and control data packets, and wherein the at least some incoming and outgoing data packets are user data packets.

12. The access port of claim 9, wherein the packet encapsulation component includes storage for encryption keys.

13. The access port of claim 9, wherein the packet encapsulation component queues the outgoing data packets in the radio for transmission to the mobile units.

14. The access port of claim 9, wherein the packet encapsulation component provides signals to the network related to flow control of the outgoing data packets.

15. A method of manufacturing an access port to be coupled to a network and configured to transmit outgoing data packets to a plurality of mobile units and to receive incoming data packets from the plurality of mobile units, the method comprising:
providing a radio to receive the incoming data packets from the mobile units and to the transmit outgoing data packets to the mobile units;
providing a packet encapsulation component coupled to the radio;
providing a processor coupled to the packet encapsulation component; and
providing an Ethernet connection coupled the processor and the packet encapsulation component and configured to be coupled to the network,
wherein the packet encapsulation component is formed by at least one of an FPGA and an ASIC.

16. The method of claim 15, wherein the packet encapsulation component encapsulates at least some the incoming data packets in accordance with an 802.3 standard and de-encapsulates at least some the outgoing data packets in accordance with an 802.11 standard.

17. The method of claim 15, wherein the incoming and outgoing data packets comprise user data packets and control data packets, and wherein the at least some incoming and outgoing data packets are user data packets.

18. The method of claim 15, wherein the packet encapsulation component includes storage for encryption keys.

19. The method of claim 15, wherein the packet encapsulation component queues the outgoing data packets in the radio for transmission to the mobile units.

20. The method of claim 15, wherein the packet encapsulation component provides signals to the network related to flow control of the outgoing data packets.
